(19) United States
(12) Patent Application Publication
(10) Pub. No.: US 2012/0097482 A1
(43) Pub. Date: Apr. 26, 2012

(54) SYSTEM FOR CHECKING OIL LEVEL

(75) Inventors: Benjamin R. Miller, Hartland, WI (US); John R. Schneiker, Muskego, WI (US); Gary J. Gracyalny, Elm Grove, WI (US)

(73) Assignee: Briggs & Stratton Corporation

(21) Appl. No.: 12/910,679

(22) Filed: Oct. 22, 2010

(51) Int. Cl. F01M 1/18; G01F 23/30

(52) U.S. Cl. 184/6.4; 73/305

(57) ABSTRACT

An engine includes a volume configured to hold oil for lubricating components of the engine, a pump, a conduit coupled to the pump and extending into the volume, and a visual interface coupled to the conduit. The conduit includes an opening located on the conduit at a position associated with a desired level for oil in the volume. When oil in the volume is at least up to the desired level, operation of the pump draws oil from the volume through the opening and into the conduit. The visual interface communicates whether or not oil in the volume is at least up to the desired level.

### BACKGROUND

The present application relates generally to the field of dipsticks for engines. More specifically the present application relates to a system for checking an oil level in an engine.

A dipstick can be used to check the oil level in an engine. Many engines include an oil fill cap with a dipstick attached to an inside surface of the fill cap. To inspect the oil level, the oil fill cap and dipstick are lifted away from a fill hole and the dipstick is wiped clean, such as with a rag or paper towel. Then the dipstick is reinserted into the fill hole and removed once again. Typically dipsticks have hash marks or pin holes indicative of a proper oil level. Visual inspection of oil clinging to the dipstick indicates the current oil level in the engine. If the oil level is too low, then additional oil may added.

### SUMMARY

One embodiment of the invention relates to an engine. The engine includes a volume configured to hold oil for lubricating components of the engine, a pump, a conduit coupled to the pump and extending into the volume, and a visual interface coupled to the conduit. The conduit includes an opening located on the conduit at a position associated with a desired level for oil in the volume. When oil in the volume is at least up to the desired level, operation of the pump draws oil from the volume through the opening and into the conduit. The visual interface communicates whether or not oil in the volume is at least up to the desired level.

Another embodiment of the invention relates to a system for checking a fluid level, which includes a conduit, a pump coupled to the conduit, a reservoir, and a float coupled to the reservoir. The reservoir receives fluid drawn through the conduit by the pump. Movement of the float indicates the presence of fluid in the reservoir.

Yet another embodiment of the invention relates to a system for checking a fluid level in a container. The system includes a conduit, a pump coupled to the conduit, and a visual interface coupled to the conduit. The conduit has an opening located on the conduit at a position associated with a desired level for fluid in the container. The pump includes a flexible surface at least partially defining a chamber of the pump, where the flexible surface is biased to return to an original shape after being pressed. When fluid in the container is at least up to the desired level, operation of the pump draws fluid through the opening and into the conduit. The visual interface communicates whether or not fluid in the container is at least up to the desired level.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, in which:

FIG. 1 is a perspective view of an engine according to an exemplary embodiment of the invention.

FIG. 2 is a sectional view of a schematic illustration of an engine according to another exemplary embodiment of the invention.

FIG. 3 is a perspective view of a system for checking a level of oil in an engine in a first configuration according to an exemplary embodiment of the invention.

FIG. 4 is a perspective view of the system of FIG. 3 in a second configuration.

FIG. 5 is an exploded view of the system of FIG. 3.

FIG. 6 is a sectional view of the system of FIG. 3, taken along line 6-6 in FIG. 3.

FIG. 7 is a side view of a system for checking a level of oil in an engine according to another exemplary embodiment of the invention.

FIG. 8 is a sectional view of the system of FIG. 7, taken along line 8-8 in FIG. 7.

FIG. 9 is an exploded view of a system for checking a level of oil in an engine according to yet another exemplary embodiment of the invention.

FIG. 10 is a sectional view of the system of FIG. 9, taken along line 10-10 in FIG. 9.

FIG. 11 is a sectional view of a system for checking a level of oil in an engine in a first configuration according to an exemplary embodiment of the invention.

FIG. 12 is a sectional view of the system of FIG. 11 in a second configuration.

FIG. 13 is a sectional view of a system for checking a level of oil in an engine according to another exemplary embodiment of the invention.

FIG. 14 is a sectional view of a system for checking a level of oil in an engine according to yet another exemplary embodiment of the invention.

FIGS. 15-18 are sectional views of a system for checking a level of oil in an engine in several different configurations according to an exemplary embodiment of the invention.

FIG. 19 is a sectional view of a system for checking a level of oil in an engine according still another exemplary embodiment of the invention.

FIG. 20 is a sectional view of a system for checking a level of oil in an engine according to another exemplary embodiment of the invention.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

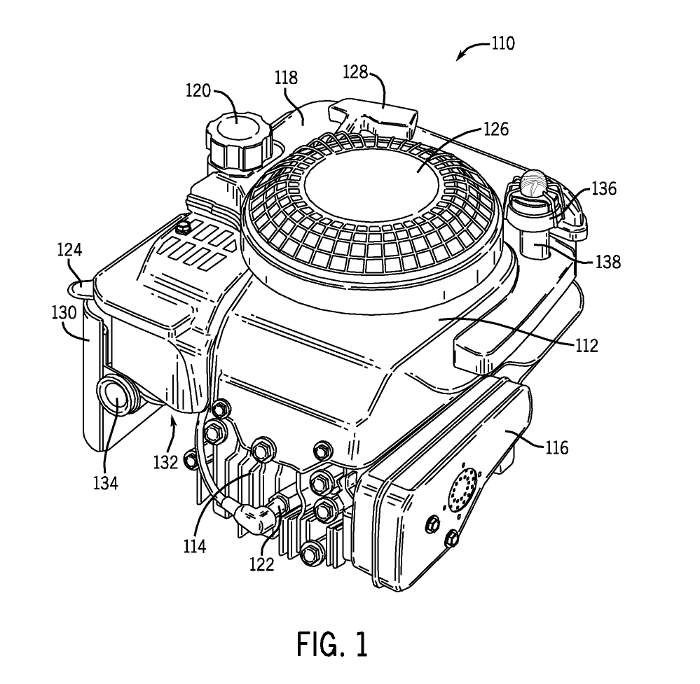

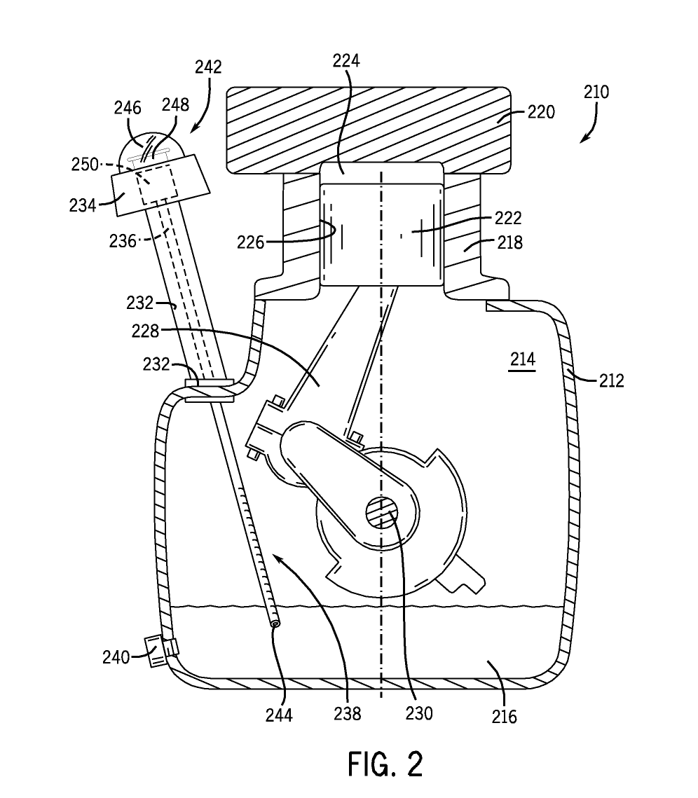

Referring to FIG. 1, an engine 110 includes a cover 112, a cylinder head 114, and a muffler 116. The cover 112 and the cylinder head 114 are fastened to an engine block of the engine 110 (see, e.g., crankcase 212 as shown in FIG. 2). In some embodiments, the engine 110 further includes a fuel tank 118 with a cap 120, a sparkplug 122, a throttle lever 124, a recoil starter 126 with a pull handle 128, an air intake 130, and a carburetor 132 with a priming bulb 134. According to an exemplary embodiment, the engine 110 still further includes an oil fill cap 136 having a visual interface of a system for checking a level of oil in the engine 110, and an oil fill chute 138 directing oil poured down the oil fill chute 138 to the crankcase (e.g., engine block).

According to an exemplary embodiment, the engine 110 is a small, single-cylinder, gasoline-powered, four-stroke cycle internal combustion engine. However a broad range of engines and other fluid holding components may benefit from the teachings disclosed herein. In some embodiments, the engine 110 is vertically shafted (as shown in FIG. 1), while in other embodiments, an engine is horizontally shafted (see engine 210 as shown in FIG. 2). For example, in some contemplated embodiments, an engine may include two, three, or more cylinders, may be a diesel engine, or may have a two-stroke cycle.

According to an exemplary embodiment, the engine 110 is configured to power a broad range of equipment, including lawn mowers, pressure washers, electric generators, snow throwers, and other equipment. In still other contemplated embodiments, the system is used to check fluids other than oil, such as antifreeze, brake fluid, water, etc., and may be used with systems other than engines, such as refrigerators, air conditioning units, hydraulic circuits, etc.

Referring to FIG. 2, an engine 210 includes a crankcase 212 defining a volume 214 holding a lubricant, such as motor oil 216. A cylinder block 218 is coupled to the crankcase 212, and a cylinder head 220 is coupled to the cylinder block 218. During operation of the engine 210, a piston 222 translates back and forth within the cylinder block 218, powered by combustion processes occurring within a combustion chamber 224 that is at least partially defined by a bore 226 of the cylinder block 218, the piston 222, and the cylinder head 220. As the piston 222 translates, a connecting rod 228 coupled to the piston 222 drives a crankshaft 230 of the engine 210. In some embodiments, movement of the crankshaft 230 facilitates spreading of the oil 216 throughout the crankcase 212, such as by way of a dipper or slinger (not shown), for lubrication and cooling of the components of the engine 210, such as the piston 222, connecting rod 228, and crankshaft 230.

According to an exemplary embodiment, the engine 210 further includes an oil fill hole 232 in the crankcase 212 (e.g., chute, oil fill tube). A cap 234 covers the oil fill hole 232, and a dipstick 236 extends from the cap 234, through the oil fill hole 232, and into the volume 214 of the crankcase 212. In some embodiments, the dipstick 236 includes markings 238 (e.g., graduated indicia, measurement lines) corresponding to different levels of oil in the crankcase 212. When the dipstick 236 is removed from the engine 210, oil on the dipstick 236 covers the dipstick 236 up to one of the markings 238, which corresponds to the current level of oil in the crankcase 212 and allows the viewer to estimate the current level of oil. If the current level is too low, oil may be added to the oil in the crankcase 212 through the oil fill hole 232. Used oil may be drained from the crankcase 212 by opening an oil drain plug 240 near a base of the crankcase 212.

In some embodiments, the engine 210 further includes a system 242 for checking a level of the oil in the engine 210 without opening the crankcase 212 of the engine 210. According to an exemplary embodiment, the system 242 provides an indication as to whether or not oil 216 in the crankcase 212 is at least up to a desired level (e.g., optimal level, predetermined level, minimum level). However, there is no need to remove the cap 234 or the dipstick 236 from the oil fill hole 232 to perform the check.

In some embodiments, the dipstick 236 is hollow (e.g., tubular) and forms a conduit extending from the cap 234 through the oil fill hole 232, and into the volume 214 of the crankcase 212. According to such an embodiment, the dipstick 236 further includes an opening 244 (e.g., intake, inlet) located on the dipstick 236 at a position associated with the desired level of the oil 216 within the crankcase 212. In other embodiments, such an opening extends from a side of the dipstick, or a dipstick includes more than one such opening.

According to an exemplary embodiment, the system 242 further includes a pump 246, which may be integrated with the cap 234 of the oil fill hole 232. In some such embodiments, the pump 246 is configured to be manually operated, such by pressing a biased plunger. In other contemplated embodiments, a pump may be electric, battery-powered, wind-up (e.g., with a torsion spring), or otherwise powered. In alternative embodiments, a pump is separated from the cap, positioned above or beneath the cap, such as within the oil fill hole 232 and coupled to the dipstick 236.

During use of the system 242, the pump 246 is operated to provide suction along the conduit of the dipstick 236. If the opening 244 of the dipstick 236 is at or below the level of oil 216 in the crankcase 212, then some of the oil will be suctioned through the opening 244 and into the conduit of the dipstick 236. If the opening 244 of the dipstick 236 is above the level of oil in the crankcase 212, then generally no oil will be suctioned through the opening 244. Instead, air from within the crankcase 212 will be drawn into the conduit of the dipstick 236.

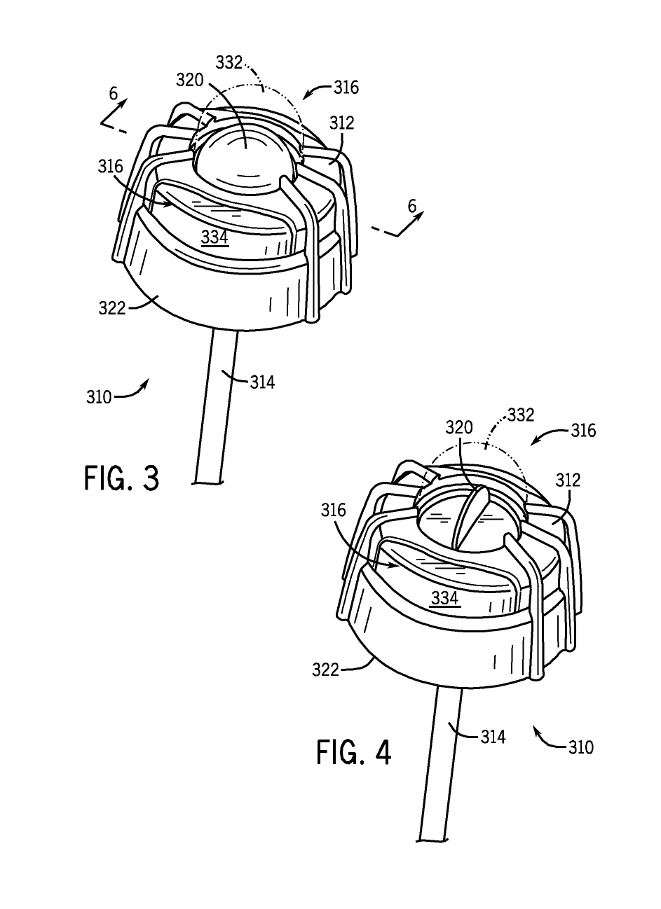

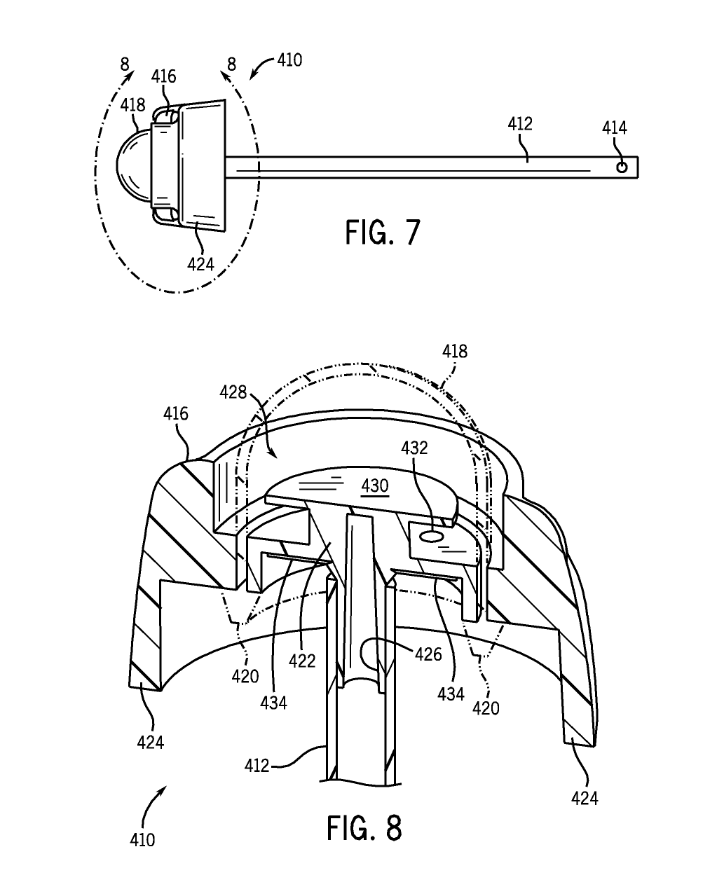

According to an exemplary embodiment, the system 242 further includes a visual interface 248 for identifying to an operator of the engine 210 whether or not the oil 216 in the crankcase 212 is at least up to the desired level. In some embodiments, the visual interface 248 includes a reservoir 250 (e.g., temporary reservoir, collection reservoir, volume, chamber) which receives oil 216 drawn from the crankcase 212 by the dipstick 236. In some such embodiments, the visual interface 248 further includes a clear plastic or glass wall (e.g., translucent wall, window; see generally FIGS. 7-8, 11-12, and 14-21) allowing the operator to see whether oil was received by the reservoir 250, indicating that the current level is at least up to the desired level—or, conversely the absence of oil in the reservoir 250, indicating that the current level is below the desired level. In other embodiments, floats (e.g., buoys, floating components) move in response to the presence of oil in the reservoir 250 (see generally FIGS. 3-6, 9-10, and 13).

Referring now to FIGS. 3-6, a system 310 for checking a level of oil in an engine includes a conduit 314, a pump 316 (FIG. 6), a collection reservoir 318 (FIG. 6), and a float 320. According to an exemplary embodiment, the pump 316, collection reservoir 318, and float 320 are integrated with a cap 312 designed for fastening to an opening in an engine or another container of liquid (see, e.g., oil fill hole 232 of engine 210 as shown in FIG. 2). In some such embodiments, a portion of the cap 312 is molded from nylon and includes a skirt 322 (e.g., flange, overhang) or surface having a coupling for fastening the cap 312 to the opening, such as a pressure-fit coupling, threaded male or female coupling, snap-fit coupling, or another form of coupling. According to an exemplary embodiment, the reservoir 318 is positioned at least partially within the cap 312, and the float 320 is positioned at least partially within the reservoir 318. The conduit 314 (e.g., dipstick, tube) extends from the reservoir 318, away from the cap 312.

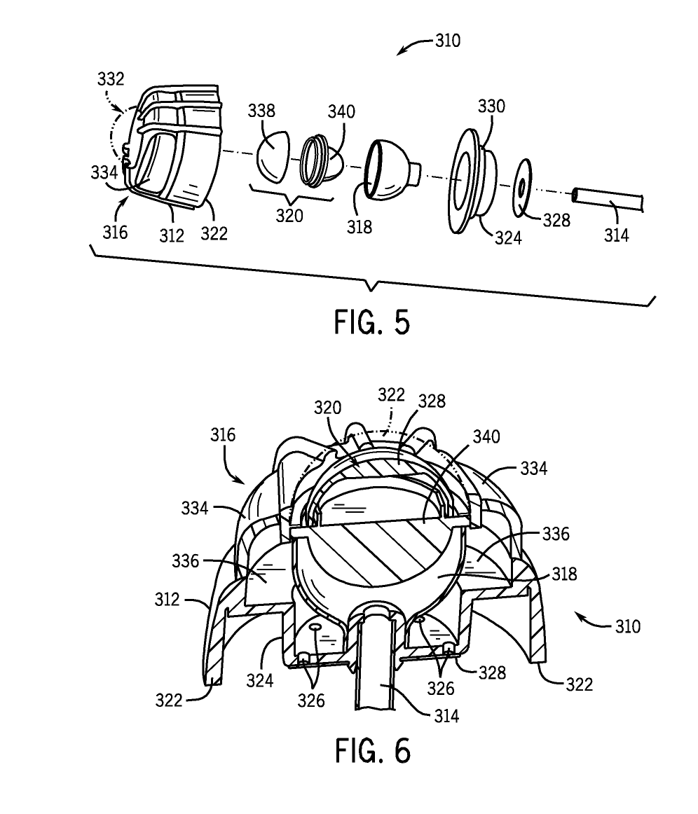

According to an exemplary embodiment, a bottom 324 (FIG. 5) of the cap 312 includes openings 326 and a check valve 328 (e.g., flap valve) for venting or drainage. An O-ring 330 or another seal may be integrated with the bottom 324 of the cap 312. In some embodiments, the cap 312 further includes a translucent dome 332 that separates the float 320 from outside air. The dome 332 may be molded from a clear plastic, such as TR-90-LX. In contemplated embodiments, the conduit 314 is formed from brass, steel, nylon, or another material.

According to an exemplary embodiment, the pump 316 includes two flexible surfaces 334 (e.g., bulbs). In some such embodiments the flexible surfaces 334 are formed from squeeze molded flexible nylon. The flexible surfaces 334 at least partially define an annular pumping chamber 336 of the system 310. During operation, compression of one or both of the flexible surfaces 334 decreases the volume of the pumping chamber 336. Use of two flexible surfaces 334 on opposite sides of the cap 312 is intended to be ergonomically beneficial to the operator, by allowing the operator to pinch the cap with the thumb on one flexible surface and index, middle, and ring fingers on the other flexible surface.

Upon compression of the flexible surfaces 334, air or liquid in the pumping chamber 336 is driven out of the pumping chamber 336 through the openings 326, and is prevented from reentering the pumping chamber 336 by the check valve 328. The flexible surfaces 334 are biased to their initial shapes, such that when the flexible surfaces 334 are released, a low pressure is generated in the pumping chamber 336. If the level of liquid is below the inlet of the conduit 314, substantially only air will flow into and through the conduit 314. However, if the level of liquid is at least up to an inlet (see, e.g., opening 244 as shown in FIG. 2) of the conduit 314, the low pressure draws liquid into and through the conduit 314 to the reservoir 318 (e.g., tower). Following a check of the liquid level, the check valve 328 allows the liquid to drain from the collection reservoir 318 and to flow beneath the cap 312.

According to an exemplary embodiment, the float 320 includes a first side 338 that is buoyant, and a second side 340 that is lighter than the first side 338, but not buoyant. In some embodiments, the first side 338 is green and the second side 340 is red. Without liquid in the collection reservoir 318, gravity pulls the first side 338 down, and the second side 340 is visible on top of the system 310 (see FIG. 4). The presence of a sufficient amount of liquid in the collection reservoir 318 causes the float 320 to rotate so that the first side 338 is visible on top of the system 310 (see FIG. 3).

Referring now to FIGS. 7-8, a system 410 for checking a level of oil in an engine (see, e.g., engine 110 as shown in FIG. 1) includes a substantially straight, tubular conduit 412 having an intake 414 (FIG. 7) on an end of the conduit 412, and a cap 416 on another end of the conduit, opposite to the end with the intake 414. The cap 416 includes a clear, flexible, molded nylon-12 bulb 418. A lip 420 (FIG. 8) of the bulb 418 serves as an O-ring seal between an inner piece 422 (FIG. 8) and an outer skirt 424 of the cap 416. The inner piece 422 includes a flow path 426 for receiving oil from the conduit 412, and directing the oil to a reservoir 428 (e.g., volume, chamber) between the inner piece 422 and the bulb 418. While the tubular conduit 412 is shown as substantially straight in FIGS. 7-8, in other contemplated embodiments similar tubular conduit could be curved or flexible, without a rigid, straight structure.

Compression of the bulb 418 is resisted by a bias of the bulb 418 to return to the initial, hemispherical shape of the bulb 418. A top 430 (FIG. 8) of the inner piece 422 serves as a shield, limiting the compression of the bulb 418 and preventing the bulb 418 from sealing the conduit 412 when the bulb 418 is fully pressed down. After the bulb 418 is released from compression, the bulb 418 generates a low pressure in the reservoir 428. The low pressure draws oil through the conduit 412, if the level of oil in the engine is at least up to the intake 414 of the conduit 412, which is associated with a desired oil level in the engine. The oil then passes through the flow path 426 of the inner piece 422 and into the reservoir 428.

Because the bulb 418 is clear (e.g., translucent, transparent) in some such embodiments, an operator of the system 410 is able to see the oil received by the reservoir 428. As such, the clear bulb 414 serves as a visual interface, identifying to the operator that the oil level in the engine is at least up to the desired level. Conversely, if the oil in the engine is below the intake 414, then oil will not be drawn into the reservoir 428 after the bulb 414 has been pressed, and the operator will see the absence of oil through the clear bulb 414, indentifying to the operator that the oil level in the engine is below the desired level.

Viewing of the oil in the reservoir 428 through the clear bulb 414 also allows the user to view the color of the oil, which may be indicative of the state of the oil. Darker oil may need to be replaced. In some contemplated embodiments, the top 430 of the inner piece 422 is white or reflective, directing light through the oil. In still other contemplated embodiments, the top 430 of the inner piece 422 may be lit with one or more light-emitting diodes, to help the operator judge the state of the oil.

According to an exemplary embodiment, the system further includes a passive drainage system. A flap valve 434 (FIG. 8) serves as a check valve or flow control valve for the system 410. One or more holes 432 (FIG. 8) in the inner piece 422 vent air to the reservoir 428 (when pressure in the reservoir is not below ambient pressure) and allow oil to drain back to the engine through an oil fill hole covered by the cap 416. However, tension in the flap valve 434 limits the rate at which oil or air flows through the holes 432. After the oil has drained from the reservoir 428, the flap valve 434 also allows air to slowly flow into to reservoir 428 and conduit 412, to allow the oil in the conduit 412 to drain.

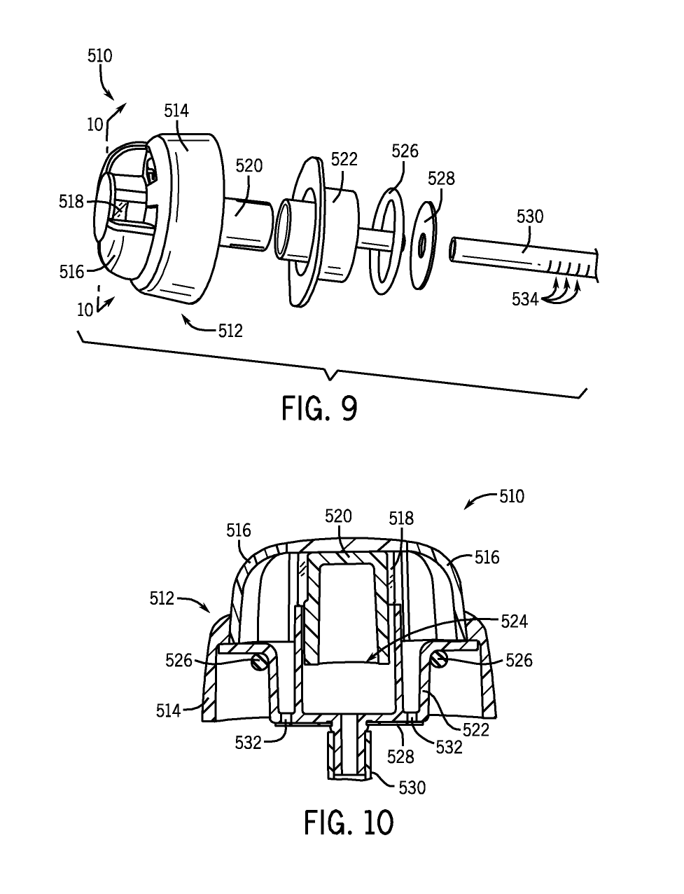

Referring to FIGS. 9-10, a system 510 for checking a level of oil in an engine includes a cap 512 having a body 514 (e.g., housing, exterior, shell), a flexible bulb 516, and a clear window 518. Each of the body 514, flexible bulb 516, and clear window 518 may be separately molded, and may be formed from nylon or another material. The system further includes a float 520 (e.g., poppet) and a bottom 522 (e.g., tower, retainer) for the cap 512.

According to an exemplary embodiment, the body 514, the flexible bulb 516, and the bottom 522 at least partially define a collection chamber 524 (FIG. 10) within the cap 512. An O-ring seal 526 serves to isolate the collection chamber 524, and a flap valve 528 at least partially controls a flow into and out of the collection chamber 524. A tube 530 is coupled to the bottom 522 of the cap 512, and is designed to communicate oil from within the crankcase (see, e.g., crankcase 212 as shown in FIG. 2) to the collection chamber 524.

During operation of the system 510, an operator manually squeezes and then releases the flexible bulb 516, which creates a vacuum in the collection chamber 524 that is communicated to the crankcase via the tube 530. If the level of oil in the crankcase is at least up to an inlet of the tube (see, e.g., opening 244 as shown in FIG. 2), located on the tube 530 at a position associated with a desired level of oil in the crankcase, then the vacuum will draw oil through the tube 530 and into the bottom 522 of the cap 512. Oil in the collection chamber 524 will cause the float 520 to translate upward and become visible behind the clear window 518. In some embodiments, at least a portion of the float 520 is green. Viewing of the float 520 through the window indicates that the oil level in the crankcase is at least up to the desired level. Following operation of the system, the oil in the collection chamber 524 will return to the crankcase through openings 532 (FIG. 10) in the collection chamber 524 and back through the tube 530.

According to an exemplary embodiment, the cap 512 and tube 530 of the system 510 are designed to be interchangeable with standard dipstick designs. In some embodiments, the tube 530 includes markings 534 (FIG. 9) on an exterior surface of the tube 530 that allow the tube 530 to function as a standard dipstick in addition to allowing an operator to check the oil level without removing the dipstick. In some embodiments, operation of the system 510 includes more than one compression and release of the flexible bulb 516, while in other embodiments, a single compression and release is sufficient to draw oil through the tube 530 and into the collection chamber 524.

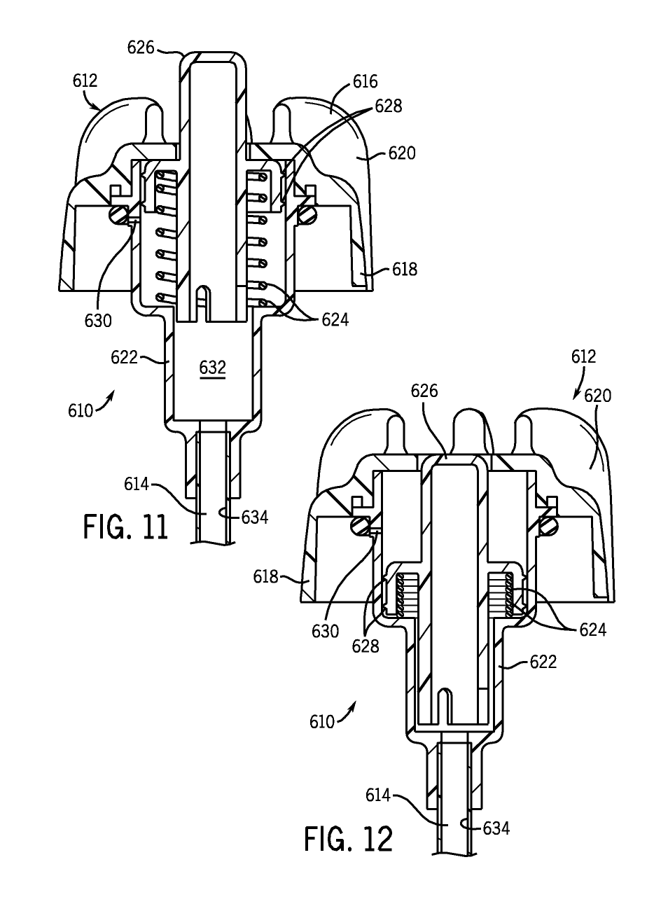

Referring now to FIGS. 11-12, a system 610 for checking a level of oil in an engine includes a cap 612 and a dipstick 614. The cap 612 includes a body 616 forming a skirt 618 or other surface having a coupling structure, and a contoured surface 620 for gripping or rotating the cap 612. Within the body 616, the cap 612 includes a receiving cup 622, a spring 624, and a rigid plunger 626. According to an exemplary embodiment, the plunger 626 is formed from a clear or translucent material (e.g., acrylic, TR-90-LX, glass). The spring 624 biases the plunger 626 to a position where at least a portion of the plunger 626 extends outward from the body 616 of the cap 612. The system 610 includes a seal 628 (e.g., one or more O-rings) between the plunger 626 and the receiving cup 622. The receiving cup 622 further includes a vent hole 630.

According to a preferred embodiment, the length of the dipstick 614 or the position of an intake (see, e.g., opening 244 as shown in FIG. 2) on the dipstick 614 is particularly designed so that when the cap 612 is fastened to an engine, the intake is positioned at a desired level of oil in the engine. During operation of the system 610, an operator presses the plunger 626 into the cap 612 (FIG. 12), and releases. The spring 624 biases the plunger 626 back to the initial position (FIG. 11), which provides low pressure in a reservoir 632 (FIG. 11) defined by the cup 622 and the plunger 626. If the level of oil in the engine is at least up to the intake of the dipstick 614, then oil is drawn through a passage 634 in the dipstick 614 to the reservoir 632. The oil in the reservoir is then visible through the clear plunger 626, which provides a visual interface for the operator to determine whether the oil level in the engine is at least at the desired level, without removing the cap 612 or dipstick 614 from the engine.

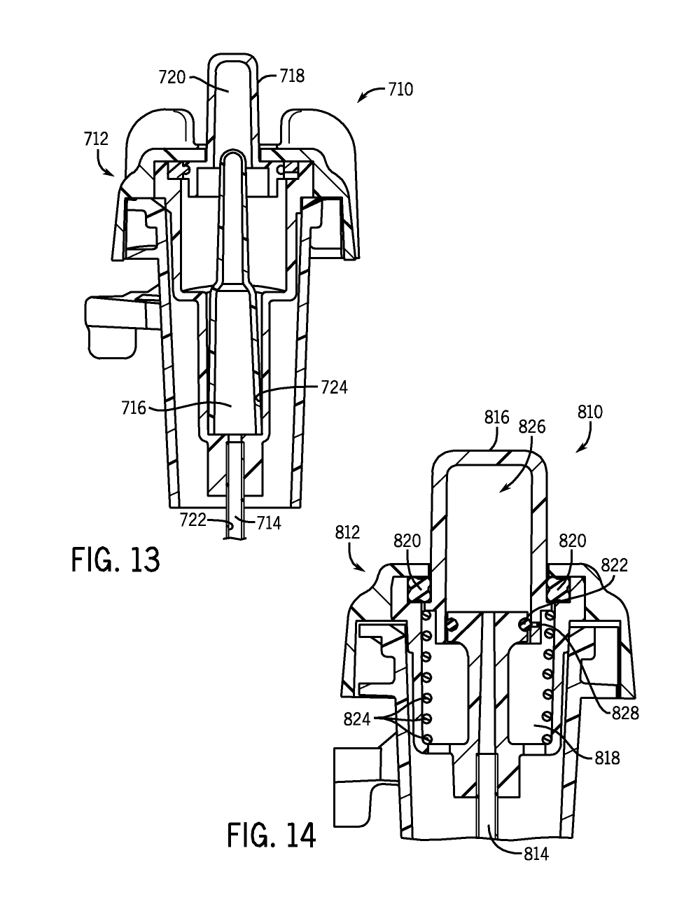

Referring to FIG. 13, a system 710 includes a cap 712 and dipstick 714 similar to the system 610, as shown in FIGS. 11-12. However, the system 710 further includes a float 716 in the form of a colored poppet. The float 716 translates upward, into a volume 720 inside a clear plunger 718 when oil is drawn from a conduit 722 in the dipstick 714 into a cup 724 beneath the float 716. Movement of the float 716 into the volume 720 inside the clear plunger 718 provides an indication that oil in the engine is at least up to a desired level. Absence of the float 716 inside the clear plunger 718 indicates that oil in the engine is below the desired level.

Referring to FIG. 14, a system 810 includes a cap 812 and tube 814, where the cap 812 includes a plunger 816 formed from a clear material (e.g., clear nylon-12), a receiving cup 818, a wiper 820, a seal 822, and a spring 824. Downward movement (e.g., depressing) of the plunger 816 is opposed by the spring 824, such that when the plunger 816 is pressed and released, the spring 824 pushes the plunger 816 back to the initial position of the plunger 816, creating a low pressure in the tube 814 beneath the plunger 816. If oil is present at the end of the tube 814 (see oil 216 as shown in FIG. 2), the oil will be drawn through the tube 814 and into a cavity 826 of the plunger 816. Oil visible through the clear material of the plunger 816 indicates to an outside observer that oil is present at a level sufficient to supply oil to the end of the tube 814.

As the plunger 816 returns to the initial position, the wiper 820 (e.g., wiper O-ring) removes oil from the surface of the plunger 816. In some embodiments, the wiper 820 also serves as a damper to slowly ease the plunger 816 back to the initial position (e.g., fully-extended position). The seal 822 (e.g., O-ring) serves to maintain the vacuum within the cavity 826 as the plunger 816 returns to the initial position. When the plunger 816 has returned to the initial position, a hole 828 (e.g., vent opening, drain hole) in the plunger 816 is opened and the oil drains back to the engine through hole and the tube 814. In some embodiments, the tube 814 is formed from aluminum or nylon-66. While in other contemplated embodiments, other materials are used, where the material is selected based upon suitability with the fluid being checked.

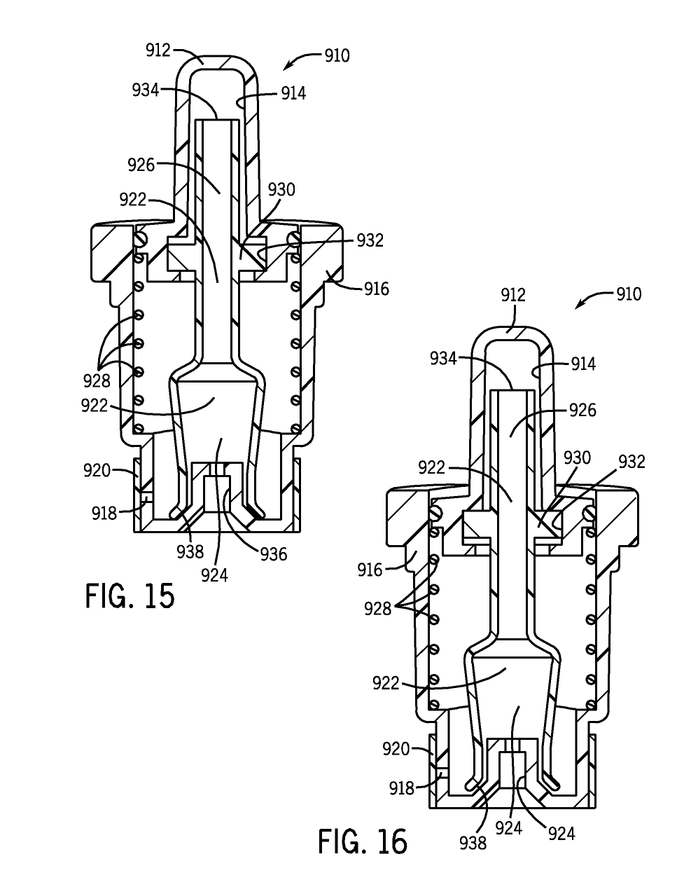

Referring to FIGS. 15-18, a system 910 includes an actuator 912 (e.g., button, clear-plastic plunger) formed from a clear or translucent material and having an interior cavity 914. The actuator 912 is translatable within a receiving cup 916 (e.g., tower, retainer, bottom of a cap). The receiving cup 916 further includes an opening 918 and a check valve 920 allowing flow out of the opening 918 (e.g., a rubber-band style seal). The system 910 further includes a pumping member 922 (e.g., pumping conduit, plunging element, compressible conduit) having a wide portion 924 and a narrow portion 926. The pumping member 922 is biased to an initial shape (FIG. 15), such as by way of a spring 928 and/or by elastic material of the pumping member 922.

An annular extension 930 from the narrow portion 926 of the pumping member 922 is received within an annular recess 932 in a base of the actuator 912, coupling the actuator 912 and the pumping member 922. The narrow portion 926 of the pumping member 922 extends into the cavity 914 of the actuator 912, and an end 934 of the narrow portion 926 is open to the cavity 914. The wide portion 924 of the pumping member 922 includes an end 938 that is directly or indirectly coupled a conduit 936 (see, e.g., tube 814 as shown in FIG. 14), which extends to a holder of a fluid (e.g., crankcase).

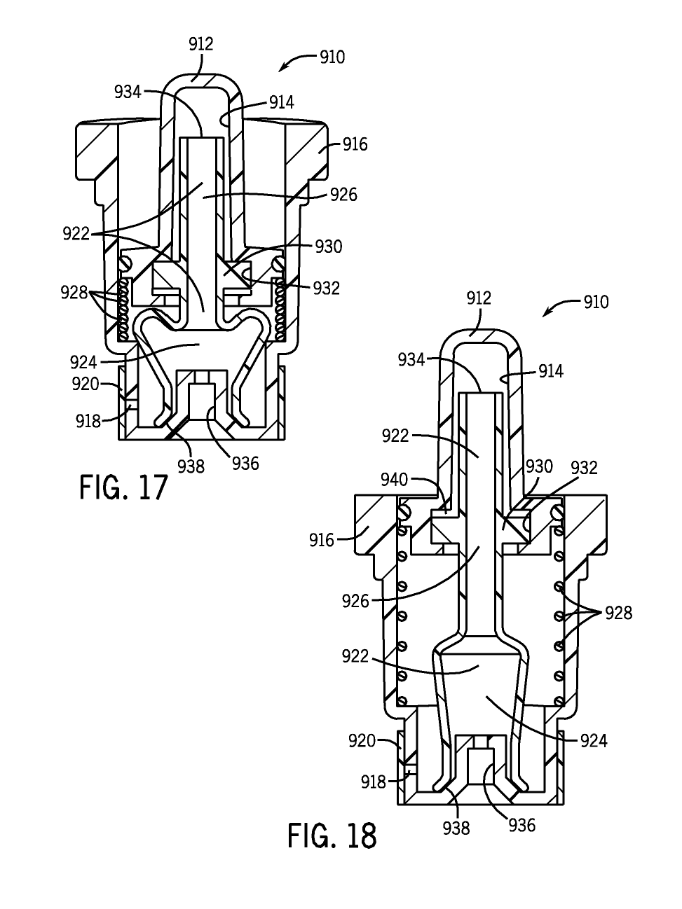

Referring to FIGS. 16-17, during operation of the system 910 an operator presses the actuator 912 (compare FIG. 16 with FIG. 17). Movement of the actuator 912 is resisted by the pumping member 922 and the spring 928. As such, the annular extension 930 of the pumping member 922 is pressed against the annular recess 932 of the actuator 912, forming a seal. The narrow portion 926 of the pumping member 922 compresses into the wider portion 924 of the pumping member 922, decreasing the volume of the pumping member 922. As the pumping member 922 is compressed, air may flow around the end 938 of the wider portion 924, and may push through the check valve 920 and out of the opening 918 in the receiving cup 916.

Referring to FIGS. 17-18, when the operator releases the actuator 912, the pumping member 922 is biased back to the initial shape (see FIGS. 15 and 18) of the pumping member 922, which has a greater volume than the compressed shape (FIG. 17). As the pumping member 922 returns to the initial shape, a low pressure is provided in the pumping member 922, which is communicated to the conduit 936 via the end 938 of the wider portion 924 of the pumping member 922. If oil or other fluid is present at an inlet (see generally opening 244 as shown in FIG. 2) of the conduit 936, then the oil or other fluid will be drawn through the conduit 936 and into the pumping member 922 and cavity 914 of the actuator 912. The oil or other fluid will then be visible to the operator through the actuator 912, indicating to the operator that the oil or other fluid was present at a level sufficient to reach the inlet of the conduit 936.

Referring to FIG. 18, the spring 928 further biases the actuator 912 such that a space 940 is provided between the annular extension 930 of the pumping member 922 and the annular recess 932 of the actuator 912. The space 940 allows for air to flow into the cavity 914 and for oil or other fluid to flow from the cavity 914. As such, following operation of the system 910, the oil or other fluid will drain from the cavity 914, back through the pumping member 922 and conduit 936, and around the annular extension 930 and through the opening 918 in the receiving cup 916. In contemplated embodiments, the ends of the spring 928 extend between the wide portion 924 of the pumping member 922 and the actuator 912. Also, in some contemplated embodiments a flange (not shown) is located along the top edge of the receiving cup 916 to provide a vertical limit for movement the actuator 912.

Referring to FIG. 19, a system 1010 for checking a level of oil in an engine includes a cap 1012 and a tubular dipstick 1014 coupled to the cap 1012. The cap 1012 includes a body 1016 forming a skirt 1018, a flexible clear bulb 1020, and a retainer 1022 for the tubular dipstick 1014. According to an exemplary embodiment, the retainer 1022 includes a snap feature 1024 for fastening the retainer 1022 to the body 1016 with an end 1026 of the bulb 1020 between the retainer 1022 and body 1016 serving as an O-ring seal and support for the fastening.

During operation of the system 1010, an operator manually presses the bulb 1020, causing an interior lip 1028 (e.g., annular extension) of the bulb 1020 to seal against the retainer 1022. After deformation, the bulb 1020 is biased to return to the initial shape of the bulb 1020, which provides a vacuum that draws oil up the tubular dipstick 1014 and into the bulb 1020, if oil is present at the intake (see, e.g., opening 244 as shown in FIG. 2) of the tubular dipstick 1014. Oil visible through the tubular dipstick 1014 serves as a visual interface identifying to the operator that the oil in the engine is at least up to a desired level. When the bulb 1020 has returned to the initial shape, the vacuum is released and the interior lip 1028 separates from the retainer 1022, allowing the oil to drain back to the engine through the tubular dipstick 1014 and a vent 1030 between the tubular dipstick 1014 and the bulb 1020.

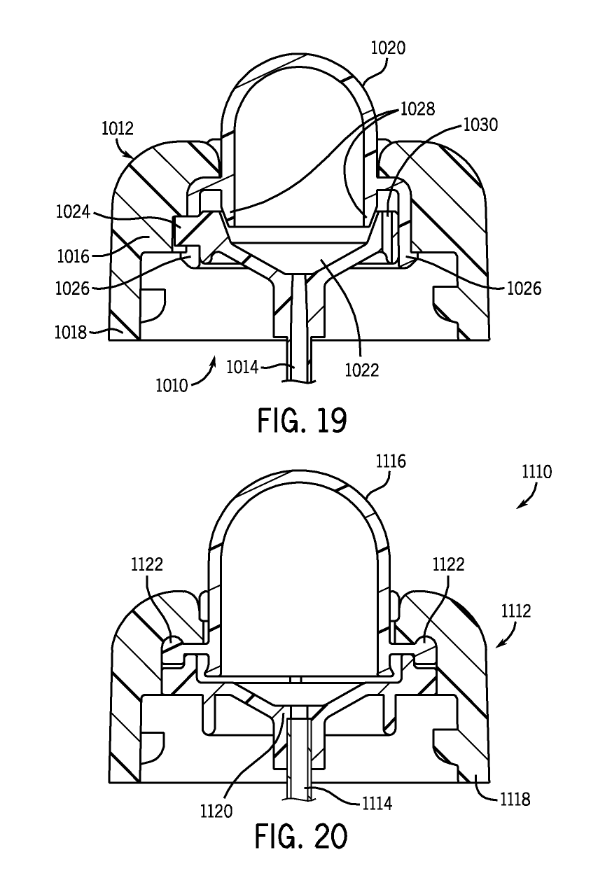

Referring to FIG. 20, a system 1110 includes a cap 1112 and a tubular dipstick 1114 coupled to the cap 1112. The cap 1112 includes a skirt 1118 and a flexible, clear bulb 1116, formed from nylon-12 in some embodiments. A retainer 1120 for the tubular dipstick 1114 is positioned within the skirt 1118, below the bulb 1116. An annular extension 1122 from the bulb 1116 provides an O-ring seal between the interior of the bulb 1116 and the skirt 1118 of the cap 1112. The system 1010 functions in a manner similar to the system 1010, where depressing the bulb 1116 creates a temporary vacuum between the bulb 1116 and the retainer 1120, drawing oil through the tubular dipstick 1114 and into visual range of the operator through the clear bulb 1116. In other contemplated embodiments, a bulb may be rigid, and the retainer is flexible for providing a vacuum (see generally plunging member 922 as shown in FIG. 17).

According to other contemplated embodiments, an operator of a system for checking a level of oil in an engine, such as a system similar to systems 242, 310, 410, 510, 610, 710, 810, 910, 1010, 1110, is able to adjust the vertical height of an intake in a tubular dipstick, without removing a cap from an oil fill hole of the engine. Adjustment of the height of the intake may allow for estimation of the current oil level, in addition to checking to see whether or not the oil level in the engine is at least up to a desired level. Iterative testing can be run, with the height of the intake incrementally raised or lowered until the visual interface provides a different result, indicating proximity to the current level of oil in the crankcase.

In some such embodiments, a retainer or bottom of the cap overlays a portion of the dipstick, such that the dipstick is able to move vertically within the retainer or bottom of the cap in order to adjust the height of the intake without raising or lowering the cap. In another such embodiment, the intake of the dipstick includes an elongate vertical opening, a series of openings along a side of the dipstick, or an adjustable sleeve extension. In such embodiments, a gate translates over the dipstick to open or close the elongate opening or to open or close some of the openings in the series to adjust the effective height of the intake. Alternatively, the sleeve is moved up or down. A dial coupled to a worm gear or rack-and-pinion coupling may be used to raise and lower the dipstick, or to raise and lower the sleeve or gate. In some contemplated embodiments, the dial may be integrated with the cap, such as in the form of an annular ring that moves relative to the skirt or exterior portion of the cap.

The construction and arrangements of the engine and system for checking a level of fluid in a holder of the fluid, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. An engine, comprising:
a volume configured to hold oil for lubricating components of the engine;
a pump;
a conduit coupled to the pump and extending into the volume, wherein the conduit comprises an opening located on the conduit at a position associated with a desired level for oil in the volume, wherein when oil in the volume is at least up to the desired level, operation of the pump draws oil from the volume through the opening and into the conduit; and
a visual interface coupled to the conduit, wherein the visual interface communicates whether or not oil in the volume is at least up to the desired level.

2. The engine of claim 1, wherein the pump is manually operated.

3. The engine of claim 2, further comprising:
an oil fill hole, wherein the conduit extends to the volume through the oil fill hole.

4. The engine of claim 3, further comprising:
a cap for the oil fill hole, wherein the visual interface and the pump are integrated into the cap.

5. The engine of claim 4, wherein the pump, the conduit, and the visual interface are configured to check and communicate whether or not oil in the volume is at least up to the desired level without removing the cap or the conduit from the oil fill hole.

6. The engine of claim 5, further comprising:
markings on the conduit to be used as a reference when viewing oil on the conduit after the conduit has been removed from the volume for estimating a current level of oil in the engine.

7. The engine of claim 5, wherein the pump comprises a flexible surface biased to return to an original shape after being pressed.

8. The engine of claim 5, wherein the pump comprises a rigid plunger biased by a spring to return to an original position after being pressed.

9. A system for checking a fluid level, comprising:
a conduit;
a pump coupled to the conduit;
a reservoir for receiving fluid drawn through the conduit by the pump; and
a float coupled to the reservoir, wherein movement of the float indicates the presence of fluid in the reservoir.

10. The system of claim 9, further comprising:
a cap, wherein the pump, the reservoir, and the float are integrated with the cap.

11. The system of claim 10, wherein the conduit extends from a bottom of the cap.

12. The system of claim 11, wherein float includes a visual indicator that is visible from outside the system when fluid is present in the reservoir.

13. The system of claim 11, wherein the float rotates to indicate the presence of fluid in the reservoir.

14. The system of claim 11, wherein the float translates to indicate the presence of fluid in the reservoir.

15. The system of claim 11, wherein the pump is manually operated and comprises a movable surface biased to return to an initial configuration after being pressed, which provides low pressure for suctioning fluid through the conduit.

16. A system for checking a fluid level in a container, comprising:
a conduit having an opening located on the conduit at a position associated with a desired level for fluid in the container;
a pump coupled to the conduit and comprising a flexible surface at least partially defining a chamber of the pump, wherein the flexible surface is biased to return to an original shape after being pressed, and wherein when fluid in the container is at least up to the desired level, operation of the pump draws fluid through the opening and into the conduit; and
a visual interface coupled to the conduit, wherein the visual interface communicates whether or not fluid in the container is at least up to the desired level.

17. The system of claim 16, further comprising:
a cap having a skirt, wherein the pump and the visual interface are integrated into the cap.

18. The system of claim 17, wherein the flexible surface comprises a flexible bulb, and wherein an end of the flexible bulb provides a seal between an interior portion of the cap in communication with the conduit and an exterior portion of the cap.

19. The system of claim 17, wherein the flexible surface of the pump comprises a pumping member coupled to the conduit, wherein the pumping member comprises two open ends and is biased to an initial shape, wherein compression of the pumping member reduces the volume of the pumping member, and wherein returning of the pumping member to the initial shape provides low pressure for suctioning fluid through the conduit.

20. The system of claim 17, wherein the visual interface comprises a float coupled to the conduit, wherein movement of the float indicates whether or not fluid in the container is at least up to the desired level.
